(19) United States
(12) Patent Application Publication
(10) Pub. No.: US 2025/0328750 A1
(43) Pub. Date: Oct. 23, 2025

(54) METHOD AND SYSTEM FOR OUT-OF-DISTRIBUTION INPUT DETECTION IN NEURAL NETWORKS

(71) Applicant: JPMorgan Chase Bank, N.A., New York, NY (US)

(72) Inventors: Mirazul HAQUE, Secaucus, NJ (US); Natraj RAMAN, London (GB); Petr BABKIN, San Francisco, CA (US)

(73) Assignee: JPMorgan Chase Bank, N.A., New York, NY (US)

(21) Appl. No.: 18/643,371

(22) Filed: Apr. 23, 2024

(51) Int. Cl. G06N 3/045

(52) U.S. Cl. CPC G06N 3/045

(57) ABSTRACT

A method and a system for using a skipping mechanism to automatically detect out-of-distribution (OOD) inputs to neural networks in an efficient and accurate manner are provided. The method includes: receiving a proposed input to a neural network at a first gate of the neural network; estimating, based on an output generated by the first gate, a first probability that the proposed input is classifiable as being OOD; forwarding the first proposed input to at least one additional gate of the neural network, including skipping at least one layer of the neural network; estimating, based on a respective output generated by each respective additional gate, a corresponding probability that the proposed input is classifiable as being OOD; and determining, based on the estimated probabilities, whether the proposed input is classifiable as being OOD by determining whether at least a minimum number of the estimated probabilities exceed a predetermined threshold.

### BACKGROUND

### 1. Field of the Disclosure

This technology relates to methods and systems for using a skipping mechanism to automatically detect out-of-distribution inputs to neural networks in an efficient and accurate manner.

### 2. Background Information

As Deep Neural Networks are being used in various fields, detecting out-of-distribution (OOD) inputs have been prioritized by a significant number of researchers. OOD inputs are examples that do not belong to the training data distribution. As these inputs would lead to incorrect prediction, it is important to detect OOD inputs so that they can be discarded.

Multiple approaches have been proposed for OOD detection. These conventional approaches use one or multiple inferences for the detection. Even the efficient OOD detection techniques use the outputs of the last layer or the penultimate layer, causing a full inference. However, as these OOD inputs will certainly cause model failure, it is very important to detect these incorrect output-generating OOD inputs without using significant computing resources.

One conventional approach proposes the use of an early-exit Dynamic Neural Network (DyNN) to detect OODs only using partial inference. Early-exit DyNNs are one of the popular types of DyNN, where the model has multiple exits and the model stops execution if one of the earlier exits is confident about the prediction. This approach proposes to use these exits to calculate whether or not a particular input is OOD, and further, the exit is selected based on input complexity, which is calculated by the bit-length of the compressed input.

However, this approach has two shortcomings. First, the methodology relating to which exit will detect the OOD in the complexity calculation (i.e., bit-length of the compressed input) is not trustworthy with respect to detecting input complexity for a DyNN, as the location and the architecture of the exit can change. Second, the early-exit DyNNs generally have a small number of exits in the architecture, which means that the OOD detection would work only when it can be performed in a small number of points.

Accordingly, there is a need for a mechanism to automatically detect out-of-distribution inputs to neural networks in an efficient and accurate manner.

### SUMMARY

The present disclosure, through one or more of its various aspects, embodiments, and/or specific features or sub-components, provides, inter alia, various systems, servers, devices, methods, media, programs, and platforms for using a skipping mechanism to automatically detect out-of-distribution inputs to neural networks in an efficient and accurate manner.

According to an aspect of the present disclosure, a method for automatically detecting out-of-distribution inputs to neural networks is provided. The method is implemented by at least one processor. The method includes: receiving, by the at least one processor, a first proposed input to a first neural network at a first gate of the first neural network; estimating, by the at least one processor based on an output generated by the first gate, a first probability that the first proposed input is classifiable as being out-of-distribution (OOD); forwarding, by the at least one processor, the first proposed input to at least a second gate of the first neural network; estimating, by the at least one processor based on a respective output generated by each respective one of the at least second gate, a corresponding probability that the first proposed input is classifiable as being OOD; and determining, based on each of the first probability and each corresponding probability, whether the first proposed input is classifiable as being OOD.

The forwarding of the first proposed input to the at least second gate of the first neural network may include skipping at least one layer of the first neural network.

The forwarding of the first proposed input to the at least second gate of the first neural network may further include forwarding the first proposed input to a final gate of the first neural network.

The estimating of the first probability may include calculating a first deep deterministic uncertainty (DDU) value with respect to the first gate, and the estimating of each corresponding probability may include calculating a respective DDU value with respect to each respective one of the at least second gate.

Alternatively, the estimating of the first probability may include calculating a first energy score with respect to the first gate, and the estimating of each corresponding probability may include calculating a respective energy score with respect to each respective one of the at least second gate.

The determining may include determining whether at least a first predetermined number of estimated probabilities exceed a first predetermined threshold value.

When the first predetermined number of estimated probabilities exceeds the first predetermined threshold value, the method may further include determining that the first proposed input is OOD and discarding the first proposed input.

When the first proposed input has been forwarded to a final gate of the first neural network and an estimation of a respective probability that the first proposed input is OOD has been performed with respect to the final gate and the first predetermined number of estimated probabilities has not exceed the first predetermined threshold value, the method may further include determining that the first proposed input is not OOD and retaining the first proposed input.

The first neural network may be usable for performing a classification task that relates to at least one from among high frequency trading, a deep learning model that is installed in a drone, a deep learning model that is installed in a self-driving automobile, and financial fraud detection.

According to another exemplary embodiment, a computing apparatus for automatically detecting out-of-distribution inputs to neural networks is provided. The computing apparatus includes a processor; a memory; and a communication interface coupled to each of the processor and the memory. The processor is configured to: receive, via the communication interface, a first proposed input to a first neural network at a first gate of the first neural network; estimate, based on an output generated by the first gate, a first probability that the first proposed input is classifiable as being out-of-distribution (OOD); forward the first proposed input to at least a second gate of the first neural network; estimate, based on a respective output generated by each respective one of the at least second gate, a corresponding probability that the first proposed input is classifiable as being OOD; and determine, based on each of the first probability and each corresponding probability, whether the first proposed input is classifiable as being OOD.

The processor may be further configured to forward the first proposed input to the at least second gate of the first neural network by skipping at least one layer of the first neural network.

The processor may be further configured to forward the first proposed input to a final gate of the first neural network.

The processor may be further configured to estimate the first probability by calculating a first deep deterministic uncertainty (DDU) value with respect to the first gate, and to estimate each corresponding probability by calculating a respective DDU value with respect to each respective one of the at least second gate.

Alternatively, the processor may be further configured to estimate the first probability by calculating a first energy score with respect to the first gate, and to estimate each corresponding probability by calculating a respective energy score with respect to each respective one of the at least second gate.

The processor may be further configured to determine whether the first proposed input is classifiable as being OOD by determining whether at least a first predetermined number of estimated probabilities exceed a first predetermined threshold value.

When the first predetermined number of estimated probabilities exceeds the first predetermined threshold value, the processor may be further configured to determine that the first proposed input is OOD and discard the first proposed input.

When the first proposed input has been forwarded to a final gate of the first neural network and an estimation of a respective probability that the first proposed input is OOD has been performed with respect to the final gate and the first predetermined number of estimated probabilities has not exceed the first predetermined threshold value, the processor may be further configured to determine that the first proposed input is not OOD and retain the first proposed input.

The first neural network may be usable for performing a classification task that relates to at least one from among high frequency trading, a deep learning model that is installed in a drone, a deep learning model that is installed in a self-driving automobile, and financial fraud detection.

According to yet another exemplary embodiment, a non-transitory computer readable storage medium storing instructions for automatically detecting out-of-distribution inputs to neural networks is provided. The storage medium includes executable code which, when executed by a processor, causes the processor to: receive a first proposed input to a first neural network at a first gate of the first neural network; estimate, based on an output generated by the first gate, a first probability that the first proposed input is classifiable as being out-of-distribution (OOD); forward the first proposed input to at least a second gate of the first neural network; estimate, based on a respective output generated by each respective one of the at least second gate, a corresponding probability that the first proposed input is classifiable as being OOD; and determine, based on each of the first probability and each corresponding probability, whether the first proposed input is classifiable as being OOD.

When executed, the executable code may further cause the processor to forward the first proposed input to the at least second gate of the first neural network by skipping at least one layer of the first neural network.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using a skipping mechanism to automatically detect out-of-distribution inputs to neural networks in an efficient and accurate manner.

FIG. 4 is a flowchart of an exemplary process for implementing a method for using a skipping mechanism to automatically detect out-of-distribution inputs to neural networks in an efficient and accurate manner.

FIG. 5 is an illustration of a model architecture for implementing a method for using a skipping mechanism to automatically detect out-of-distribution inputs to neural networks in an efficient and accurate manner, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

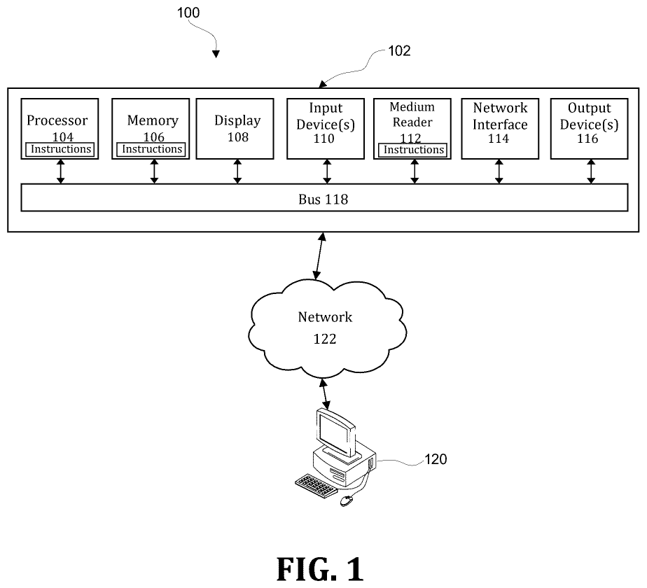

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using a skipping mechanism to automatically detect out-of-distribution inputs to neural networks in an efficient and accurate manner.

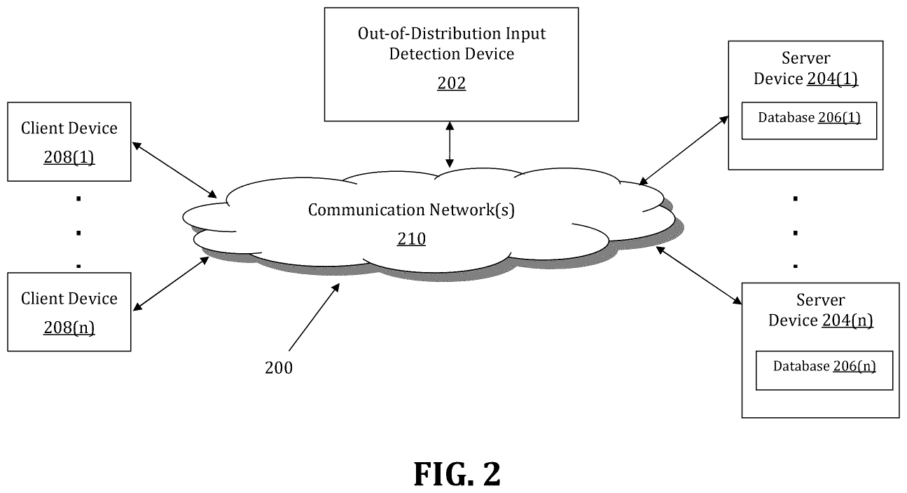

Referring to FIG. 2, a schematic of an exemplary network environment 200 for implementing a method for using a skipping mechanism to automatically detect out-of-distribution inputs to neural networks in an efficient and accurate manner is illustrated. In an exemplary embodiment, the method is executable on any networked computer platform, such as, for example, a personal computer (PC).

The method for using a skipping mechanism to automatically detect out-of-distribution inputs to neural networks in an efficient and accurate manner may be implemented by an Out-of-Distribution Input Detection (OODID) device 202. The OODID device 202 may be the same or similar to the computer system 102 as described with respect to FIG. 1. The OODID device 202 may store one or more applications that can include executable instructions that, when executed by the OODID device 202, cause the OODID device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OODID device 202 itself, may be located in virtual server(s) running in a cloud-based computing environment rather than being tied to one or more specific physical network computing devices. Also, the application(s) may be running in one or more virtual machines (VMs) executing on the OODID device 202. Additionally, in one or more embodiments of this technology, virtual machine(s) running on the OODID device 202 may be managed or supervised by a hypervisor.

In the network environment 200 of FIG. 2, the OODID device 202 is coupled to a plurality of server devices 204(1)-204 (n) that hosts a plurality of databases 206(1)-206(n), and also to a plurality of client devices 208(1)-208 (n) via communication network(s) 210. A communication interface of the OODID device 202, such as the network interface 114 of the computer system 102 of FIG. 1, operatively couples and communicates between the OODID device 202, the server devices 204(1)-204 (n), and/or the client devices 208(1)-208 (n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OODID device 202, the server devices 204(1)-204 (n), and/or the client devices 208(1)-208 (n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OODID devices that efficiently implement a method for using a skipping mechanism to automatically detect out-of-distribution inputs to neural networks in an efficient and accurate manner.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OODID device 202 may be a standalone device or integrated with one or more other devices or apparatuses, such as one or more of the server devices 204(1)-204 (n), for example. In one particular example, the OODID device 202 may include or be hosted by one of the server devices 204(1)-204 (n), and other arrangements are also possible. Moreover, one or more of the devices of the OODID device 202 may be in a same or a different communication network including one or more public, private, or cloud networks, for example.

The plurality of server devices 204(1)-204 (n) may be the same or similar to the computer system 102 or the computer device 120 as described with respect to FIG. 1, including any features or combination of features described with respect thereto. For example, any of the server devices 204(1)-204 (n) may include, among other features, one or more processors, a memory, and a communication interface, which are coupled together by a bus or other communication link, although other numbers and/or types of network devices may be used. The server devices 204(1)-204 (n) in this example may process requests received from the OODID device 202 via the communication network(s) 210 according to the HTTP-based and/or JavaScript Object Notation (JSON) protocol, for example, although other protocols may also be used.

The server devices 204(1)-204 (n) may be hardware or software or may represent a system with multiple servers in a pool, which may include internal or external networks. The server devices 204(1)-204 (n) hosts the databases 206(1)-206(n) that are configured to store information that relates to neural networks and information that relates to metrics for detecting whether an input is out-of-distribution.

Although the server devices 204(1)-204 (n) are illustrated as single devices, one or more actions of each of the server devices 204(1)-204 (n) may be distributed across one or more distinct network computing devices that together comprise one or more of the server devices 204(1)-204 (n). Moreover, the server devices 204(1)-204 (n) are not limited to a particular configuration. Thus, the server devices 204(1)-204 (n) may contain a plurality of network computing devices that operate using a master/slave approach, whereby one of the network computing devices of the server devices 204(1)-204 (n) operates to manage and/or otherwise coordinate operations of the other network computing devices.

The server devices 204(1)-204 (n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208 (n) may also be the same or similar to the computer system 102 or the computer device 120 as described with respect to FIG. 1, including any features or combination of features described with respect thereto. For example, the client devices 208(1)-208 (n) in this example may include any type of computing device that can interact with the OODID device 202 via communication network(s) 210. Accordingly, the client devices 208(1)-208 (n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208 (n) may run interface applications, such as standard web browsers or standalone client applications, which may provide an interface to communicate with the OODID device 202 via the communication network(s) 210 in order to communicate user requests and information. The client devices 208(1)-208 (n) may further include, among other features, a display device, such as a display screen or touchscreen, and/or an input device, such as a keyboard, for example.

Although the exemplary network environment 200 with the OODID device 202, the server devices 204(1)-204 (n), the client devices 208(1)-208 (n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OODID device 202, the server devices 204(1)-204 (n), or the client devices 208(1)-208 (n), for example, may be configured to operate as virtual instances on the same physical machine. In other words, one or more of the OODID device 202, the server devices 204(1)-204 (n), or the client devices 208(1)-208 (n) may operate on the same physical device rather than as separate devices communicating through communication network(s) 210. Additionally, there may be more or fewer OODID devices 202, server devices 204(1)-204 (n), or client devices 208(1)-208 (n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

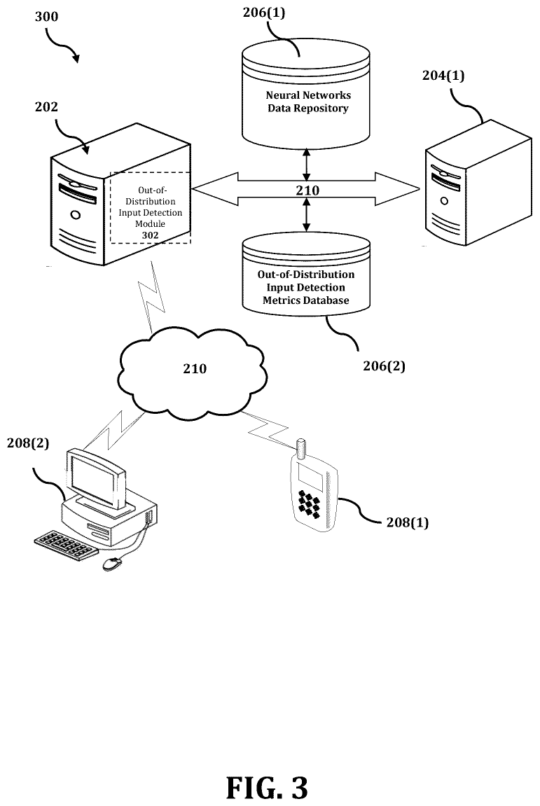

The OODID device 202 is described and illustrated in FIG. 3 as including an out-of-distribution (OOD) input detection module 302, although it may include other rules, policies, modules, databases, or applications, for example. As will be described below, the OOD input detection module 302 is configured to implement a method for using a skipping mechanism to automatically detect out-of-distribution inputs to neural networks in an efficient and accurate manner.

An exemplary process 300 for implementing a mechanism for using a skipping mechanism to automatically detect out-of-distribution inputs to neural networks in an efficient and accurate manner by utilizing the network environment of FIG. 2 is illustrated as being executed in FIG. 3. Specifically, a first client device 208(1) and a second client device 208(2) are illustrated as being in communication with OODID device 202. In this regard, the first client device 208(1) and the second client device 208(2) may be “clients” of the OODID device 202 and are described herein as such. Nevertheless, it is to be known and understood that the first client device 208(1) and/or the second client device 208(2) need not necessarily be “clients” of the OODID device 202, or any entity described in association therewith herein. Any additional or alternative relationship may exist between either or both of the first client device 208(1) and the second client device 208(2) and the OODID device 202, or no relationship may exist.

Further, OODID device 202 is illustrated as being able to access a neural networks data repository 206(1) and an out-of-distribution input detection metrics database 206(2). The OOD input detection module 302 may be configured to access these databases for implementing a method for using a skipping mechanism to automatically detect out-of-distribution inputs to neural networks in an efficient and accurate manner.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OODID device 202 via broadband or cellular communication. Of course, these embodiments are merely exemplary and are not limiting or exhaustive.

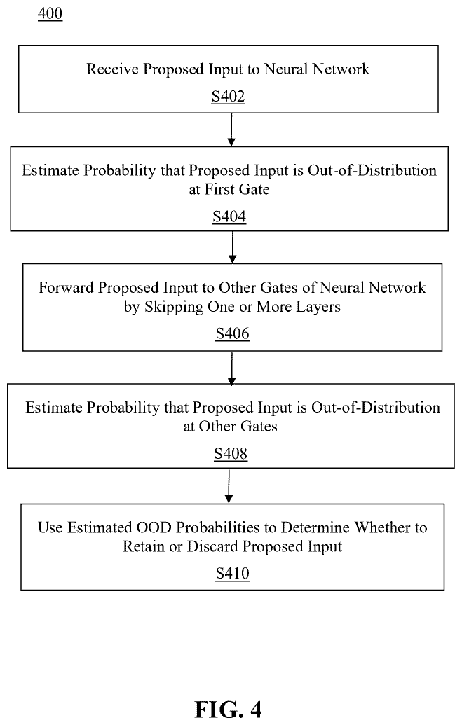

Upon being started, the OOD input detection module 302 executes a process for using a skipping mechanism to automatically detect out-of-distribution inputs to neural networks in an efficient and accurate manner. An exemplary process for using a skipping mechanism to automatically detect out-of-distribution inputs to neural networks in an efficient and accurate manner is generally indicated at flowchart 400 in FIG. 4.

In process 400 of FIG. 4, at step S402, the OOD input detection module 302 receives a proposed input to a neural network at a first gate of the neural network. In an exemplary embodiment, the neural network is usable for performing classification tasks, such as, for example, tasks that relate to high frequency trading; tasks that relate to a deep learning model that is installed in a drone; tasks that relate to a deep learning model that is installed in a self-driving automobile; and/or tasks that relate to financial fraud detection.

At step S404, the OOD input detection module 302 uses an output of the first gate of the neural network to estimate a probability that the proposed input is classifiable as being an OOD input. In an exemplary embodiment, this estimation may be performed by calculating a first deep deterministic uncertainty (DDU) value with respect to the first gate. Alternatively, in another exemplary embodiment, this estimation may be performed by calculating a first energy score with respect to the first gate.

At step S406, the OOD input detection module 302 forwards the proposed input from the first gate to at least a second gate of the neural network. In an exemplary embodiment, the OOD input detection module 302 forwards the input by skipping a layer of the neural network. In this aspect, the OOD input detection module may selectively skip certain layers of the neural network.

At step S408, the OOD input detection module 302 uses an output of the second gate of the neural network to estimate a probability that the proposed input is classifiable as being an OOD input. In an exemplary embodiment, similarly as described above with respect to step S404, this estimation may be performed by calculating a second deep deterministic uncertainty (DDU) value with respect to the second gate. Alternatively, in another exemplary embodiment, this estimation may be performed by calculating a second energy score with respect to the second gate.

In an exemplary embodiment, steps S406 and S408 may be repeated several times, depending on the number of gates included in the neural network. In an exemplary embodiment, the execution of steps S406 and S408 may end when a final gate is reached and a final estimation of a respective probability that the proposed input is classifiable as being an OOD input is made.

At step S410, the OOD input detection module 302 uses the estimated probabilities obtained in steps S404 and S408 to determine whether the proposed input is classifiable as being an OOD input. In an exemplary embodiment, this determination is made by comparing each individual estimated probability with a predetermined threshold value. When the number of individual estimated probabilities exceeding the threshold value is greater than a predetermined maximum, the OOD input detection module 302 may determine that the proposed input is an OOD input and therefore discard the proposed input. It is noted that such a discarding of the proposed input may be made as soon as the number of individual estimated probabilities exceeds the predetermined maximum, in order to prevent unnecessary further computations. Conversely, when the final gate is reached and the final estimation of the respective probability that the proposed input is OOD is made and the number of individual probabilities exceeding the threshold value is not greater than the predetermined maximum, the OOD input detection module may determine that the proposed input is not OOD and therefore retain the proposed input.

As deep neural networks are being used in various fields, detecting OOD inputs have been prioritized by a significant number of researchers. OOD inputs are examples that do not belong to the training data distribution. As these inputs would lead to incorrect prediction, there is a need to detect and discard OOD inputs.

The present inventive concept makes use of a popular type of dynamic neural networks (hereinafter “DyNN”), which may be referred to as Skipping DyNNs for OOD detection. In an exemplary embodiment, Skipping DyNNs select which of the DyNN layers and/or blocks are to be executed based on intermediate computing units. Regarding the notion that the task entails selection or removal of a layer or block, the computing units perform as binary classifiers, thereby requiring significantly lesser computing units than would be required by a multi-class internal classifier in an early-exit DyNN. For this reason, a greater number of computing units can be positioned within the network. According to an exemplary embodiment, the present inventive concept provides a system that may be referred to herein as SkipOOD.

Motivation: 1) OOD inputs represent a type of inputs that a deep learning model cannot handle. 2) As the deep learning model would always provide wrong outputs based on OOD inputs, it becomes important to detect these inputs, also in a quick way. 3) Otherwise, these OOD inputs would waste computation, resulting in power wastage. 4) In an exemplary embodiment, SkipOOD can be used to detect and discard any samples with little computation.

Use Cases: In an exemplary embodiment, SkipOOD can be used in conjunction with any system that is used for classification tasks, such as: 1) high frequency trading systems; 2) deep learning models installed in drones or self-driving automobiles; and 3) financial fraud detection systems. In addition, SkipOOD may be used effectively and efficiently for performing hallucination detection tasks in large language models.

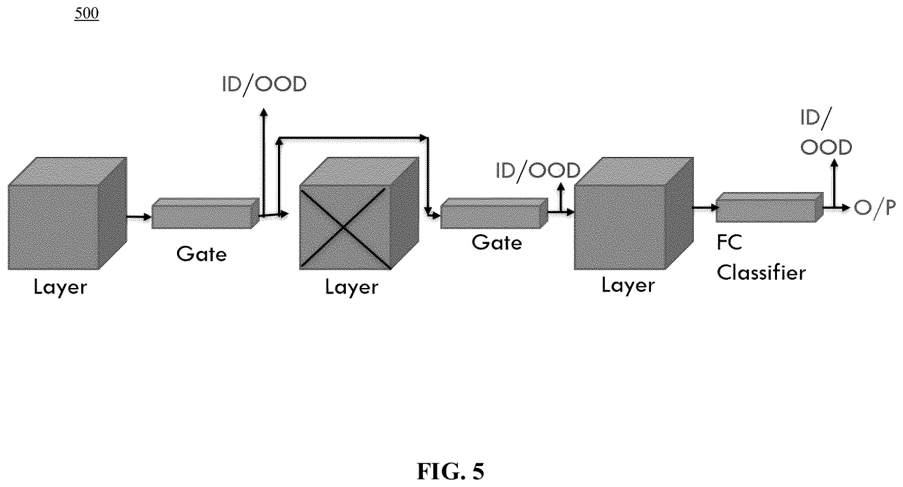

FIG. 5 is an illustration 500 of a model architecture for implementing a method for using a skipping mechanism to automatically detect out-of-distribution inputs to neural networks in an efficient and accurate manner, according to an exemplary embodiment.

Referring to FIG. 5, in an exemplary embodiment, the SkipOOD system makes advantageous use of an OOD detection technique that leverages the gating mechanism of conditional-skipping DyNNs. If an input is detected as OOD, an objective of the SkipOOD system is to make an exit after partial inference. In this aspect, it has been found that multiple skipping gates have the capability to detect OODs. However, it is important to make such a determination based on which prediction model will detect whether or not an input is OOD.

For that purpose, the following rule is proposed:

$${OOD}^{x} = {OOD}_{gate}^{x} ⋁ {OOD}_{final}^{x}$$

where x is an input, OOD is a Boolean variable that indicates whether or not x is an OOD input, OOD^{x}_{gate} is the OOD prediction at the gating mechanism level, and OOD^{x}_{final} is the OOD prediction at the final layer.

Conventional OOD detection procedures generally focus on the detection at the final layer level. By contrast, the SkipOOD system focuses on predictions at both the gating mechanism and the final layer. Conventional techniques have previously addressed OOD^{x}_{final}; however, in an exemplary embodiment, an important objective relates to addressing OOD^{x}_{gate}.

In an exemplary embodiment, the approach of finding OOD gate is divided into two steps: 1) Uncertainty Measurement; and 2) Exit.

Uncertainty Measurement: In order to make a prediction as to whether or not a particular input is OOD, epistemic uncertainty measurement has been considered as a reliable technique. The uncertainty is generally measured on last layer or penultimate layer outputs. In an exemplary embodiment, an objective is to perform uncertainty measurement on gate outputs, which are designated for deciding whether or not a next layer and/or block will be executed. As there is a focus on efficiency of OOD detection, it is important to consider OOD detection techniques which do not significantly increase the latency of the inference. For that purpose, two different popular resource-efficient uncertainty measurement methodologies are considered: 1) deep deterministic uncertainty (DDU); and 2) energy score.

DDU: The DDU technique represents one of the most resource-efficient techniques for measuring epistemic uncertainty. DDU uses the density of the Gaussian Mixture Model (GMM) to measure uncertainty. When an input is OOD, its GMM density is measured as low, whereas when an input is in-distribution, its GMM density is measured as high. Accordingly, for a given input x, the DDU density at the final layer can be measured by using the following expression:

$${UNC}_{x} = log {\sum }_{i = 1}^{K} 𝒩 ( f ( x ; θ ) , {μ}_{i} , {σ}_{i} )$$

In the above expression, K is the number of output labels, μ is the distribution mean, σ is the distribution standard deviation, and θ is the model penultimate layer output. OOD.

For the uncertainty measurement at the gate level, each gate would have different epistemic uncertainty value, which can be represented as follows:

$${UNC}_{x}^{j} = log {\sum }_{i = 1}^{K} 𝒩 ( {g}_{j} ( x ; {θ}_{j} ) , {μ}_{i}^{j} , {σ}_{i}^{j} )$$

Energy Score: Energy score is another efficient metric used to detect OOD samples. The energy score is calculated based on the outputs of a neural network, leveraging the softmax probabilities of the class predictions. The energy score for a sample (x) is defined as follows:

$$E ( x ) = - log {\sum }_{i = 1}^{K} {e}^{{f}_{i} ( x )}$$

where K is the number of classes, and fᵢ(x) represents the logits (i.e., pre-softmax activation outputs) of the model for class i and input x. Lower energy scores indicate samples that are more likely to belong to the distribution of the training data, while higher scores suggest OOD samples. In an exemplary embodiment, a negative energy score is used for OOD detection, as negative energy scores of OOD inputs are lower. By setting a threshold on the negative energy score, the SkipOOD system can effectively flag or reject inputs that are likely to be OOD.

For a specific gate j, the uncertainty measurement using energy score can be expressed as follows:

$${UNC}_{x}^{j} = log {\sum }_{i = 1}^{K} {e}^{{f}_{i}^{j} ( x )}$$

Exit: In an exemplary embodiment, another objective is to choose an exit strategy that corresponds to determining that a particular input is OOD. Although uncertainty may be calculated at each gate, it does not fully solve the problem of efficient OOD detection because multiple gates may have different predictions. Hence, it is important to know which predictions are most reliable. One prior work proposes a technique based on input complexity. This approach calculates the complexity of a particular input based on a bit-length of a corresponding compressed input. The drawback of this approach is that there has not been substantiation of the notion that the complexity calculation based on bit-length is related to the complexity calculation in DyNN. Hence, a measurement of the complexity of a particular input may be different for different DyNNs.

In an exemplary embodiment, an alternative strategy referred to herein as patience-based exit is employed. This strategy allows for an exit decision only after a series of t consecutive exits have agreed on the same prediction. Unlike some conventional methods for OOD detection, the patience-based exit strategy ignores the requirement for consecutive exits. Instead, if t gates classify a sample as being OOD, it is deemed as being OOD. Here, t represents a user-configurable threshold that may be adjusted according to the limitations of available resources.

In the context of this strategy, a counter variable cnt^{x} is introduced. The counter variable records the frequency with which a sample x is identified as being OOD across different exits. The updating process for cnt^{x} is detailed by the following formula: Before any exits occur, cnt^{x} is set to 0. At any subsequent exit, if the UNC^{j}ₓ is below a certain threshold t, then cnt^{x} is incremented.

The update rule for cnt^{x} is governed by the following equation:

$${cnt}_{i}^{x} = \{ \begin{matrix}{cnt}_{i - 1}^{x} + 1 , & if {UNC}_{x}^{j} < τ \\ {cnt}_{i - 1}^{x} , & if {UNC}_{x}^{j} \geq τ \\ 0 , & if i = 0\end{matrix}$$

This equation succinctly captures how the counter cnt^{x} evolves based on the comparison of log density against the threshold t, thereby facilitating the identification of OOD samples.

Accordingly, with this technology, an optimized process for using a skipping mechanism to automatically detect out-of-distribution inputs to neural networks in an efficient and accurate manner is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for automatically detecting out-of-distribution inputs to neural networks, the method being implemented by at least one processor, the method comprising:
receiving, by the at least one processor, a first proposed input to a first neural network at a first gate of the first neural network;
estimating, by the at least one processor based on an output generated by the first gate, a first probability that the first proposed input is classifiable as being out-of-distribution (OOD);
forwarding, by the at least one processor, the first proposed input to at least a second gate of the first neural network;
estimating, by the at least one processor based on a respective output generated by each respective one of the at least second gate, a corresponding probability that the first proposed input is classifiable as being OOD; and
determining, based on each of the first probability and each corresponding probability, whether the first proposed input is classifiable as being OOD.

2. The method of claim 1, wherein the forwarding of the first proposed input to the at least second gate of the first neural network comprises skipping at least one layer of the first neural network.

3. The method of claim 2, wherein the forwarding of the first proposed input to the at least second gate of the first neural network further comprises forwarding the first proposed input to a final gate of the first neural network.

4. The method of claim 1, wherein the estimating of the first probability comprises calculating a first deep deterministic uncertainty (DDU) value with respect to the first gate, and the estimating of each corresponding probability comprises calculating a respective DDU value with respect to each respective one of the at least second gate.

5. The method of claim 1, wherein the estimating of the first probability comprises calculating a first energy score with respect to the first gate, and the estimating of each corresponding probability comprises calculating a respective energy score with respect to each respective one of the at least second gate.

6. The method of claim 1, wherein the determining comprises determining whether at least a first predetermined number of estimated probabilities exceed a first predetermined threshold value.

7. The method of claim 6, further comprising: when the first predetermined number of estimated probabilities exceeds the first predetermined threshold value, determining that the first proposed input is OOD and discarding the first proposed input.

8. The method of claim 6, further comprising: when the first proposed input has been forwarded to a final gate of the first neural network and an estimation of a respective probability that the first proposed input is OOD has been performed with respect to the final gate and the first predetermined number of estimated probabilities has not exceed the first predetermined threshold value, determining that the first proposed input is not OOD and retaining the first proposed input.

9. The method of claim 1, wherein the first neural network is usable for performing a classification task that relates to at least one from among high frequency trading, a deep learning model that is installed in a drone, a deep learning model that is installed in a self-driving automobile, and financial fraud detection.

10. A computing apparatus for automatically detecting out-of-distribution inputs to neural networks, the computing apparatus comprising:
a processor;
a memory; and
a communication interface coupled to each of the processor and the memory,
wherein the processor is configured to:
receive, via the communication interface, a first proposed input to a first neural network at a first gate of the first neural network;
estimate, based on an output generated by the first gate, a first probability that the first proposed input is classifiable as being out-of-distribution (OOD);
forward the first proposed input to at least a second gate of the first neural network;
estimate, based on a respective output generated by each respective one of the at least second gate, a corresponding probability that the first proposed input is classifiable as being OOD; and
determine, based on each of the first probability and each corresponding probability, whether the first proposed input is classifiable as being OOD.

11. The computing apparatus of claim 10, wherein the processor is further configured to forward the first proposed input to the at least second gate of the first neural network by skipping at least one layer of the first neural network.

12. The computing apparatus of claim 11, wherein the processor is further configured to forward the first proposed input to a final gate of the first neural network.

13. The computing apparatus of claim 10, wherein the processor is further configured to estimate the first probability by calculating a first deep deterministic uncertainty (DDU) value with respect to the first gate, and to estimate each corresponding probability by calculating a respective DDU value with respect to each respective one of the at least second gate.

14. The computing apparatus of claim 10, wherein the processor is further configured to estimate the first probability by calculating a first energy score with respect to the first gate, and to estimate each corresponding probability by calculating a respective energy score with respect to each respective one of the at least second gate.

15. The computing apparatus of claim 10, wherein the processor is further configured to determine whether the first proposed input is classifiable as being OOD by determining whether at least a first predetermined number of estimated probabilities exceed a first predetermined threshold value.

16. The computing apparatus of claim 15, wherein the processor is further configured to: when the first predetermined number of estimated probabilities exceeds the first predetermined threshold value, determine that the first proposed input is OOD and discard the first proposed input.

17. The computing apparatus of claim 15, wherein the processor is further configured to: when the first proposed input has been forwarded to a final gate of the first neural network and an estimation of a respective probability that the first proposed input is OOD has been performed with respect to the final gate and the first predetermined number of estimated probabilities has not exceed the first predetermined threshold value, determine that the first proposed input is not OOD and retain the first proposed input.

18. The computing apparatus of claim 10, wherein the first neural network is usable for performing a classification task that relates to at least one from among high frequency trading, a deep learning model that is installed in a drone, a deep learning model that is installed in a self-driving automobile, and financial fraud detection.

19. A non-transitory computer readable storage medium storing instructions for automatically detecting out-of-distribution inputs to neural networks, the storage medium comprising executable code which, when executed by a processor, causes the processor to:
receive a first proposed input to a first neural network at a first gate of the first neural network;
estimate, based on an output generated by the first gate, a first probability that the first proposed input is classifiable as being out-of-distribution (OOD);
forward the first proposed input to at least a second gate of the first neural network;
estimate, based on a respective output generated by each respective one of the at least second gate, a corresponding probability that the first proposed input is classifiable as being OOD; and
determine, based on each of the first probability and each corresponding probability, whether the first proposed input is classifiable as being OOD.

20. The storage medium of claim 19, wherein when executed, the executable code further causes the processor to forward the first proposed input to the at least second gate of the first neural network by skipping at least one layer of the first neural network.
